(19) United States
(12) Patent Application Publication
(10) Pub. No.: US 2026/0037230 A1
(43) Pub. Date: Feb. 5, 2026

(54) STATIC ANALYSIS TECHNIQUES FOR DYNAMIC COMPUTER PROGRAMMING LANGUAGE

(71) Applicant: CrowdStrike, Inc., Sunnyvale, CA (US)

(72) Inventors: Eyal Mamo, Tel Aviv (IL); Amir Sidis, Tel Aviv-Yafo (IL); David Ben David, Tel Aviv-Yafo (IL); Rotem Har-Chen, Tel Aviv-Yafo (IL)

(21) Appl. No.: 18/789,144

(22) Filed: Jul. 30, 2024

(51) Int. Cl. G06F 8/30

(52) U.S. Cl. CPC G06F 8/31

(57) ABSTRACT

A method includes accessing code of an application written in a dynamic programming language, wherein the application includes a set of transition points, detecting values in the code of the application, wherein a first value of the values is associated with a first transition point of the set transition points, and iteratively resolving the first transition point to the first value of the plurality of values or another transition point. The method further includes generating a value transition graph comprising a set of nodes and a set of edges connecting the set of nodes, wherein each node of the set of nodes represents a resolved transition point of the set of transition points and generating a node in the value transition graph for the first transition point in response to resolving the first transition point to the first value.

### TECHNICAL FIELD

Aspects of the present disclosure relate to computer code analysis, and more particularly, to static analysis for dynamic computer programming languages.

### BACKGROUND

A dynamic programming language is a high-level programming language which executes certain functions at runtime, which static programming languages perform during compilation. As compared to static programming languages, values, functions, and types can be dynamically determined at runtime rather than at compilation. Static analysis of computer code includes collecting information and analyzing the expected behavior and operation of the computer code based on the computer code itself rather than operation of the code during execution (e.g., via dynamic analysis).

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram illustrating an example system architecture for static analysis of code in a dynamic programming language, in accordance with some embodiments of the present disclosure.

FIG. 2 is a block diagram that illustrates an example of static analysis for code in a dynamic programming language, in accordance with some embodiments of the present disclosure.

FIG. 3 is a block diagram illustrating an example system for static analysis of an application in a dynamic programming language, in accordance with embodiments of the present disclosure.

FIG. 4 is a flow diagram of an example method of static analysis of an application in a dynamic programming language, in accordance with some embodiments of the present disclosure.

FIG. 5 is a block diagram of an example computing device that may perform one or more of the operations described herein, in accordance with some embodiments of the present disclosure.

### DETAILED DESCRIPTION

Dynamic programming languages provide many advantages over static programming languages including the flexibility to be deployed in varying environments and to adjust the implementation of the application code, as necessary, at runtime of the application. For example, dynamic programming languages can modify a type or object system during runtime, such that new objects can be generated from runtime definitions and can alter the way existing types behave during runtime. Additionally, dynamic programming languages can use dynamic type systems as well as variable memory allocation.

While dynamic programming languages provide flexibility and streamlined development, the complexities of dynamic programing languages pose particular challenges in code analysis of an application prior to deployment of the application. The dynamic nature of dynamic programming languages that provide the various advantages also makes static analysis of an application difficult because the code may be implemented in various different ways at runtime.

The present disclosure addresses the above-noted and other deficiencies by providing a monitoring environment in which an application in a dynamic programming language is deployed to a runtime environment, after which the deployed code is copied to the monitoring environment for analysis. Embodiments provide a collector to identify, copy, and provide the deployed code of the application to the monitoring environment. The monitoring environment may perform static analysis of the application via a code analyzer and a code resolver.

In some embodiments, the code analyzer may identify portions of code that are not utilized during operation of the application (e.g., values or functions that are declared but never used or called by another function). Additionally, the code analyzer may identify which portions of the code should be resolved by determining or filtering the code based on transition points that are to be resolved to a predetermined value or type. The code resolver may then iteratively resolve each transition point that should be resolved. A transition point may be any assignment of a value, function, attribute, etc. within the code. Because a transition point may resolve to another transition point, the code resolver may iteratively resolve the transition points until all transition points have been resolved to a final value and not to another transition point. The monitoring environment may generate a value-transition graph that includes the transition points and their resolved values. For example, the value-transition graph may include nodes representing transition points with edges that create paths from transition points to their resolved value or transition point.

As discussed herein, the present disclosure provides an approach that improves the operation of a computer system by providing the capability to perform static analysis of applications written in a dynamic programming language.

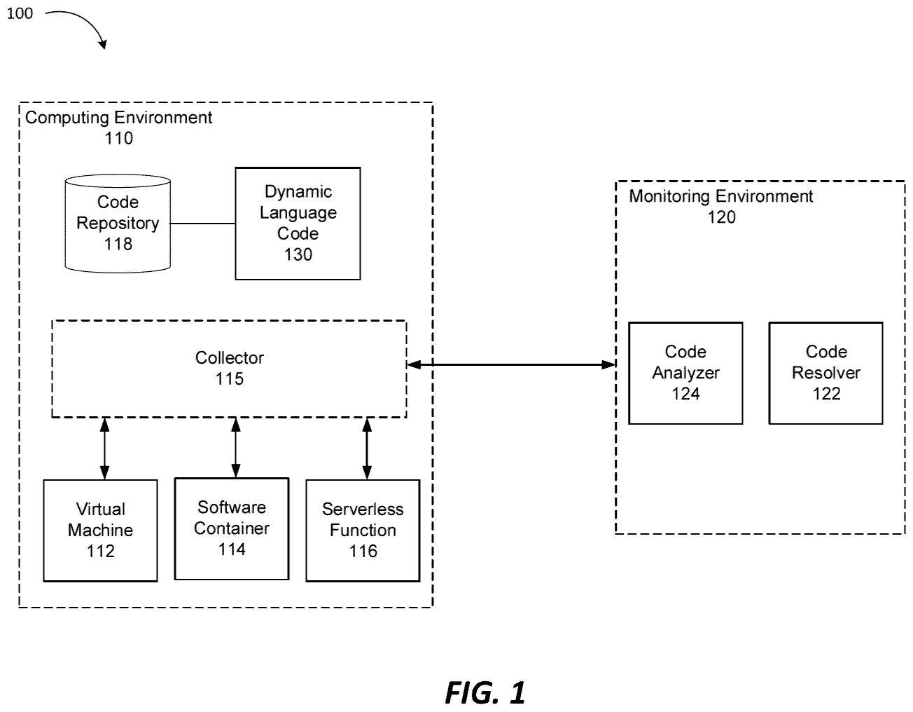

FIG. 1 illustrates an example computing architecture 100 including a computing environment 110 monitored by a monitoring environment 120, implemented in accordance with an embodiment. In an embodiment, a monitoring environment 120 is a cloud computing environment, including, for example virtual private clouds (VPCs), virtual networks (VNets), and the like. In certain embodiments, the cloud computing environment is deployed on a cloud computing infrastructure, such as Amazon® Web Services (AWS), Microsoft® Azure, Google® Cloud Platform (GCP), and the like. In some embodiments the computing environment 110 and the monitoring environment may be any data processing device, such as a server, cloud computing environment, desktop computer, a laptop computer, a mainframe computer, a personal digital assistant, a rack-mount server, a hand-held device or any other device configured to process data.

In some examples, the monitoring environment 120 includes a code resolver 122. According to some embodiments, the code resolver 122 is configured to receive computer code of an application written in a dynamic programming language, and resolve the code of the application to generate a call graph. In some embodiments, a call graph includes a representation of relationships between functions in a program, dependencies between functions, values, and the like.

In some examples, the monitoring environment 120 is communicatively coupled with a computing environment 110. For example, in some embodiments, the computing environment 110 is a cloud computing environment, such as a virtual private cloud. In some embodiments, the computing environment 110 includes resources, principals, and the like.

According to some embodiments, a principal entity is a cloud entity which is authorized to initiate actions in a cloud computing environment, act on resources in the cloud computing environment, initiate combinations thereof, and the like. A principal entity is, for example, a user account, a service account, a role, and the like.

In some examples, a resource is a cloud-based computing entity which provides access to a hardware, a service, a combination thereof, and the like. A resource is, for example, a virtual machine, a software container, a container node, a container pod, a serverless function, a microservice, an appliance, an application, combinations thereof, and the like. For example, in some embodiments, the computing environment 110 includes a virtual machine 112, a software container 114, a serverless function 116, and a code repository 118. In some embodiments, the virtual machine 112 may be implemented using any virtualization platform. In some embodiments, the software container 114 may be implemented utilizing any container orchestration platform. In some embodiments, a serverless function 116 may be implemented using any serverless platform for instantiating and managing deployment of serverless functions.

According to some examples, a code repository 118 may include a storage, such as a distributed storage system, on which code for applications written in a dynamic programming language is stored, for example as scripts, libraries, classes, code objects, code snippets, text files, combinations thereof, and the like.

According to some embodiments, a dynamic programming language is a high-level programming language which executes certain functions at runtime, which static programming languages perform during compilation. Some well-known examples of dynamic programming languages include Python™, Java™, Per™, and Ruby™. In dynamic languages, type systems are often not finalized and are subject to modification at runtime. Furthermore, types can be utilized in a data flow as a value, parameter, and the like. For example, a given call site does not have a constant target to its call and may change at runtime depending on a value of a given variable. This presents a challenge when performing static analysis of programs and applications writing in dynamic programming languages.

For example, in some embodiments, the code repository includes a dynamic language code 130 (e.g., code of an application written in a dynamic programming language). In some embodiments, the code resolver 122 is configured to access the code repository 118 in order to access the dynamic language code 130.

In certain embodiments, a resource of the computing environment 110 is configured to obtain a copy of the dynamic language code 130 and execute the code on the resource. For example, in an embodiment, the virtual machine 112 is configured to download a copy of the dynamic language code 130 from the code repository 118 and execute the copy of the dynamic language code 130 on the virtual machine 112. In some embodiments, a resource of the computing environment 110 is configured to install a collector 115. In other embodiments, the resource of the computing environment 110 is instantiated with the collector 115 (e.g., the image of the resource includes the collector 115). In an alternative embodiment, the collector 115 may be deployed to a separate resource or computing entity external to the resource executing the dynamic language code 130. In an embodiment, the collector 115 is configured to detect a dynamic language code executed on the resource (e.g., the copy of the dynamic language code 130 on the virtual machine 112) and send the code to the monitoring environment 120. In some embodiments, a code analyzer 124 may determine which portions of the dynamic language code 130 are to be resolved by the code resolver 122. For example, the code analyzer may identify transition points as well as the type or value to which the transition point is to be resolved. Additionally, the code analyzer 124 may identify which portions of code are not utilized.

Embodiments describes are thus advantageous as only code which is actually deployed in a computing environment, such as a production environment, is used for analysis. Therefore, only code which is actually deployed is resolved, thus reducing computer processing and resource utilization.

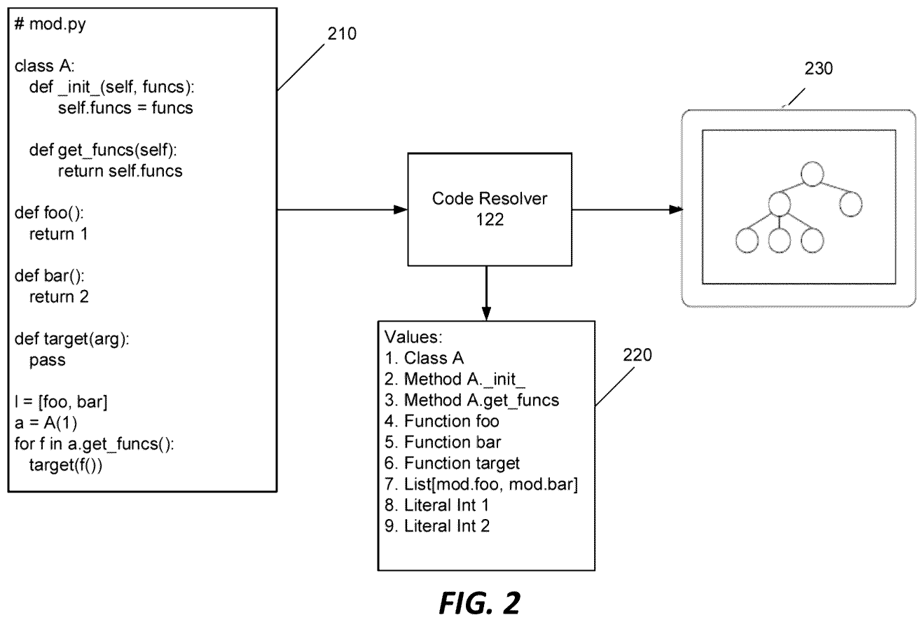

FIG. 2 is an example schematic diagram of dynamic language code resolution, implemented in accordance with an embodiment. In certain embodiments, a code, code object, and the like, are received by a code resolver 122. In an embodiment, a code portion 210 includes:
# mod.py
class A:
   def_init (self, funcs):
      self.funcs=funcs
   def get_funcs(self):
      return self funcs
   def foo( ):
      return 1
   def bar( ):
      return 2
   def target(arg):
      pass
   l=[foo, bar]
   a=A(l)
   for f in a.get_funcs( ):
      target(f( ))

The code portion 210 is provided to the code resolver 122. Code resolver 122 may be the same or similar to as code resolver 122 described with respect to FIG. 1. In some examples, the code resolver 122 is configured to detect transition points in the code portion 210. According to some embodiments, a transition point is a statement in the code portion 210 where a function, a variable, and the like, receive a value, a value placeholder, or the like.

According to some embodiments, a call graph, transition graph, and the like, is stored as a textual file, such that a node is referenced as a text field, and a predefined character serves to represent an edge. For example in the text “A->B”, “A” and “B” are nodes, and “->” is a predefined character representing an edge.

In some embodiments, the code resolver 122 is configured to resolve transition points detected in the code portion 210. Resolving a transition point may include determining the value, value placeholder, or transition point that is being assigned by the statement corresponding to the transition point. In some examples, a transition point is resolved by iteratively resolving multiple transition points. For example, a transition point may resolve to one or more additional transition point(s), which are in turn resolved until a transition point resolves ultimately to a value.

For example, according to some embodiments, a first iteration on the code portion 210 resolves “a” as the return of a call to “A”, and resolves funcs accordingly:
a=A(l)
# mod.A._init_.funcs->{mod.l}
# mod.a->{mod.A}
   At the first iteration the function call is resolved into two new transition points, one connecting the argument to the parameter, and one connecting the return value to the call point. This is expressed as mod.A.__init__.funcs being resolved to mod.l and mod.a is resolved to mod.A, as two new transitions, which can now be utilized in resolving transitions in the next iteration.

According to some embodiments, it is advantageous to avoid propagating the value of mod.A._init_.funcs to mod.A.funcs even though both can be resolved. This would quickly result in a graph explosion, which would require more storage, additional memory, and additional processing each time the graph is accessed due to its larger size. In certain embodiments, it is advantageous to resolve a specific transition, set of transitions, and the like, to a value. In such embodiments, the specific transition, for example, can be resolved recursively to a value. This avoids having to resolve each such transition by only performing such an operation on an as-needed basis. The resulting translation graph is utilized, according to an embodiment, in resolving to the value.

At a second iteration the attribute a.get_funcs is resolved, since a is resolved in the previous iteration, therefore:
for f in a.get_funcs( ):
# mod.a.get_funcs->{mod.A.get_funcs}
   In this iteration, mod.a.get_funcs is resolved into mod.A.get_funcs.

In an embodiment, the call to a.get_funcs is now resolved, as a.get_funcs is itself resolved.

In some examples, the code resolver 122 is configured to detect values 220 from the code 210. In an embodiment, the values 220 include integers, variables, lists, functions, methods, classes, and the like. In some examples, each transition point detected in the code 210 is resolved to a value of the values 220, to a previously resolved transition point, or the like.

In some embodiments, the code resolver 122 is configured to generate a call graph 230 based on the resolved code. For example, in an embodiment, a call graph is a data structure, such as a tree or directional graph including nodes (e.g., representing transition points, values, variables, etc.) and edges connecting the nodes.

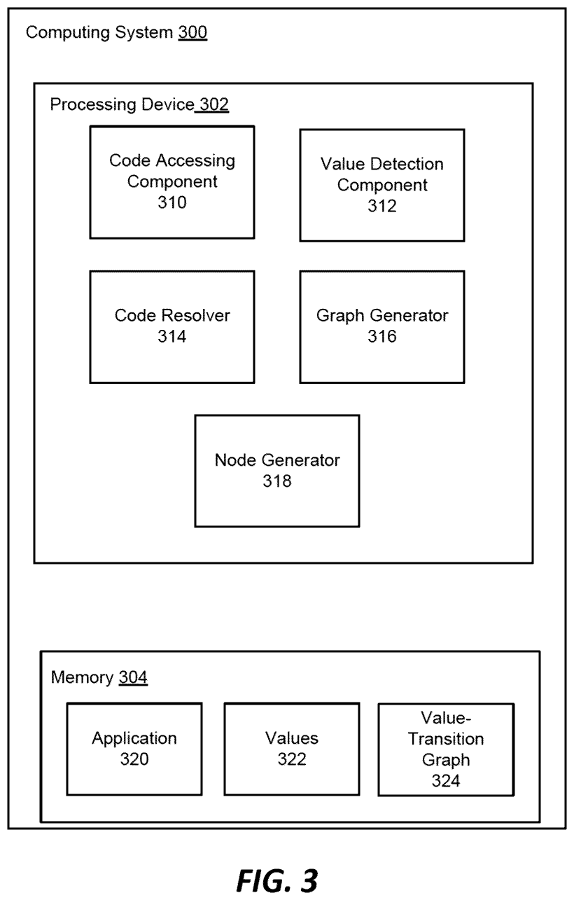

FIG. 3 block diagram depicting an example of a computing system 300 for static analysis of code in a dynamic programming language, according to some embodiments. While various devices, interfaces, and logic with particular functionality are shown, it should be understood that computing system 300 includes any number of devices and/or components, interfaces, and logic for facilitating the functions described herein. For example, the activities of multiple devices may be combined as a single device and implemented on the same processing device (e.g., processing device 302), as additional devices and/or components with additional functionality are included.

The computing system 300 includes a processing device 302 (e.g., general purpose processor, a PLD, etc.), which may be composed of one or more processors, and a memory 304 (e.g., synchronous dynamic random-access memory (DRAM), read-only memory (ROM)), which may communicate with each other via a bus (not shown).

The processing device 302 may be provided by one or more general-purpose processing devices such as a microprocessor, central processing unit, or the like. In some embodiments, processing device 302 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. In some embodiments, the processing device 302 may include one or more special-purpose processing devices such as an application specific integrated circuit (ASIC), a field programmable gate array (FPGA), a digital signal processor (DSP), network processor, or the like. The processing device 302 may be configured to execute the operations described herein, in accordance with one or more aspects of the present disclosure, for performing the operations and steps discussed herein.

The memory 304 (e.g., Random Access Memory (RAM), Read-Only Memory (ROM), Non-volatile RAM (NVRAM), Flash Memory, hard disk storage, optical media, etc.) of processing device 302 stores data and/or computer instructions/code for facilitating at least some of the various processes described herein. The memory 304 includes tangible, non-transient volatile memory, or non-volatile memory. The memory 304 stores programming logic (e.g., instructions/code) that, when executed by the processing device 302, controls the operations of the computing system 300. In some embodiments, the processing device 302 and the memory 304 form various processing devices and/or circuits described with respect to computing system 300.

The processing device 302 executes a code accessing component 310, a value detection component 312, a code resolver 314, graph generator 316, and node generator 318. In some embodiments, the code accessing component 310 may access code of an application 320 from a code repository or other data store. The code accessing component 310 may, for example, retrieve and execute the code in a runtime environment. The code accessing component 310 may further extract the code from the runtime environment during execution of the code and provide the code to a monitoring and analysis environment. In some examples, the code accessing component 310 may be the same or similar to collector 115 described with respect to FIG. 1. In some embodiments, the value detection component 312 may identify values defined within the code obtained by the code accessing component 310 from the runtime environment. The values 322 identified by the value detection component 312 may include name, type, attribute, or other data item that does not resolve to another or data item. The values 322 may also include a class, an object, a function, a list, a literal, and so forth.

In some embodiments, the code resolver 314 may be the same or similar to code resolver 122, described with respect to FIG. 1. The code resolver 314 may identify transition points within the code of the application 320 retrieved by the code accessing component 310. The code resolver may iteratively resolve the transition points to their final resolved values. For example, some transition points may resolve to other transition points. Accordingly, the code resolver 314 may resolve additional transition points during each iteration of transition point resolving until all transition points have been resolved to a final value or to a value placeholder. While the code resolver 314 resolves each transition point, the graph generator 316 may generate a value-transition graph 324 that includes the resolved transition points mapped to their resolved values or another transition point. The node generator 318 may add additional nodes to the value-transition graph 324 at each new transition point that is resolved. In some embodiments, the graph generator 316 may also generate additional graphs based on the value-transition graph 324. For example, the graph generator 316 may generate a call graph, an attribute graph, or a subscript graph based on the value-transition graph 324.

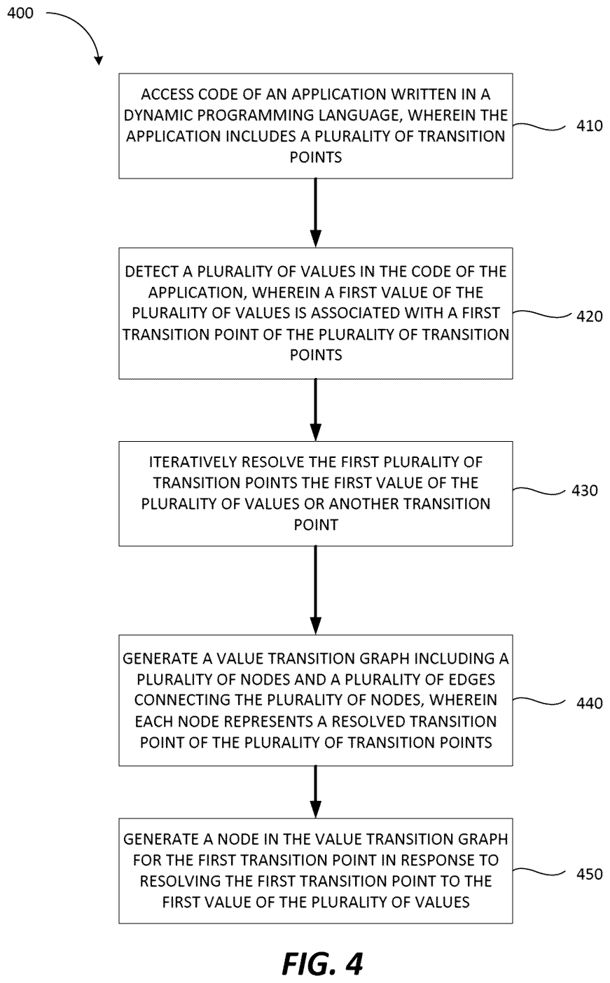

FIG. 4 is a flow diagram of a method 400 of static analysis of an application in a dynamic programming language, in accordance with some embodiments of the present disclosure. Method 400 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 400 may be performed by code resolver 122 of monitoring environment 120.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 300. It is appreciated that the blocks in method 400 may be performed in an order different than presented, and that not all of the blocks in method 400 may be performed.

With reference to FIG. 4, method 400 begins at block 410, where processing logic (e.g., monitoring environment 120 of FIG. 1 and/or collector 115 of FIG. 1) accesses code of an application written in a dynamic programming language. In some examples, the dynamic language may include multiple transition points, values, or a combination of transition points and values. In some embodiments, a value includes a portion of code which stands alone and does not point to, or call, any other piece of code. For example, the line of code “a=7” is a transition point where “a” receives a value of “7”, and is therefore resolved to “7”. In some examples, the variable “a” is resolved to a function, another variable, a plurality of transition points, an assignment, or other assignable data.

In some embodiments, a dynamic language is a high-level programming language which performs certain behaviors, such as extension of objects and definitions, addition of new code, or other code management tasks, at runtime which are typically performed during compilation in a static programming language. For example, dynamic programming languages include Python™, Java™, Per™, and Ruby™.

In some examples, the processing logic accesses the code from a code repository. A code repository may be a local or third-party managed repository that is accessible via a network. In some examples, access permissions may restrict access to the code from networks that are not associated with the code (e.g., where the code is not deployed).

In some examples, a collector may be configured to self-install on a resource in a computing environment, detect a dynamic language code executed on the resource, and send the code to a monitoring environment. Because the code is deployed on a running resource (e.g., a virtual machine, software container, etc.) and may be altered from the code that is present at the repository, the installation of the collector at the running resource may capture and analyze code that is actually executed in a production environment, rather than unmodified code of the repository.

At block 420, processing logic (e.g., monitoring environment 120, code analyzer 124, and/or code resolver 122) detects a plurality of values in the code of the application. In some embodiments, a first value of the plurality of values is associated with a first transition point of the plurality of transition points. In some examples, a value is a class, a method, a function, a list, an integer, a floating point, a combination thereof, or any assignable data. In some embodiments, a value is a code object which is utilized in the code. In some examples, some values are utilized in the code while others are not. For example, some values may be remnants of older code which has not been deleted, values which were defined but not utilized in the code implementation, or the like.

In some examples, it may be beneficial to identify values that are not used so there is no need to resolve them in the final code at runtime. In some examples, only values which are utilized in some way are resolved. For example, a piece of code may include a definition for a function. A code analyzer configured to scan the code detects that the function is called by another section of the code. Therefore, the function is a value that should be resolved at runtime. If, however, the code analyzer determined that the function is not called within the code then resolving the function is unnecessary and a waste of computing resources (e.g., memory). Accordingly, the processing logic may determine not to resolve the function when it is not used anywhere else in the code in order to conserve memory and reduce utilization of processing resources.

In some examples, only transitions of predetermined type are resolved in the value transition graph. In certain embodiments, a transition which is detected to be of a certain predetermined type or not of a predetermined type, is not resolved. In some examples, a predefined transition is a transition that facilitates inter-procedural flow (e.g., that allows data to flow from one part of the code to another part of the code). In some examples, a predefined transition type may be a call, an attribute, a subscript, a collection access, an iteration, or the like, or any combination thereof.

In some examples, a plurality of values are represented as a collection, a subscript, or the like. For example, lists, dictionaries, tuples, sets, generators, and the like, are represented and referenced in a dynamic code as a collection. In some embodiments, a collection is represented as a compound object in the transition graph.

In some embodiments, the compound object represents a data structure including a plurality of buckets, each bucket mapping a set of key names to a set of value names. In some embodiments, an identifier of the collection is resolved to a collection a first iteration to resolve a lookup in a dynamic code, and a match is determined between a set of names that a provided key is resolved to, and a key of a bucket in the collection. In some examples, a match to a bucket returns a set of value names.

A block 430, processing logic (e.g., monitoring environment 120 and/or code resolver 122) iteratively resolves the first transition point of the plurality of transition points to the first value associated with the first transition point or another transition point. In some examples, only transitions which are of a predetermined type are resolved. In some examples, a transition point is resolved iteratively. For example, a first function is called in a portion of code and receives a value from a second function. The first function is therefore resolved to the second function during a first iteration. At the next iteration, the second function may be resolved, where conditions are met (e.g., where the second function is of the predetermined type).

In some examples, a transition point is a called name, a called function, a called library, a called class, a parent definition, an attribute definition, a subscript, or the like, or a combination thereof. According to some examples, processing logic resolves detected transition points until an iteration where no additional transition points are resolved. For example, an iteration where no values are added to the call graph is the iteration where resolution stops because all transition points have been resolved.

In some examples, processing logic stores values of a current iteration in a cache. The unresolved transition points of the next iteration are resolved to the values stored in the cache. Values that are resolved may then be removed from the cache for the following iteration. In some examples, the cache may be cleared, evicted, or the like, between iterations.

At block 440, processing logic (e.g., monitoring environment 120 and/or code resolver 122) processing logic generates a value transition graph including a plurality of nodes and plurality of edges connecting the plurality of nodes. Each node in the value transition graph may represent a resolved transition point of the plurality of transition points. In some example, representing a resolved transition in the value graph may include generating a node representing a name, generating a node representing a value, and generating an edge connecting the two nodes. In some examples, processing logic may resolve a transition to a plurality of values. For example, a function may call multiple other functions, define multiple variables, or multiples of any assignable value, or combinations therefore.

At block 450, the processing logic generates a node in the value transition graph for the first transition point in response to resolving the first transition point to the first value of the plurality of values. In some examples, processing logic stores each resolved transition in a value graph. The value graph may include transitions which are ultimately resolved to values, which is a subset of resolved transitions, as certain transitions are resolved to other transition points. In some examples, a transition is fully resolved once the transition point is ultimately resolved to a value. In some embodiments, a transition is resolved to another transition. In some embodiments, the value transition graph is used to generate a call graph, a subscript graph, an attribute graph, or a combination thereof. In some examples, each of the above graphs are subgraphs of the value transition graph.

In some examples, the code analyzer detects a function call in a dynamic code. In some examples, a value of the function that is being called by the function call is resolved in the value transition graph. Such a resolution may be stored in a call graph. In some examples, the code analyzer may generate an attribute graph based on the value transition graph. For example, an attribute function, such as store, load, etc. is detected in the dynamic code. In some examples, a parent is resolved by detecting a data field preceding the attribute. For example, a dynamic language may be configured to indicate an attribute by separating two data fields with a predefined character (e.g., a delimiter), such as a period. For example, a code analyzer is configured to resolve parent2.parent1.attribute by detecting the attribute, resolving parent1 to be a parent of attribute, and resolving parent2 as being a parent to parent1. In some examples, processing logic resolves data fields iteratively until a parent is detected which is not an attribute, child, and the like, of another parent.

In some examples, the code analyzer may generate a subscript graph. In some examples the code analyzer may detect a predetermined character, set of characters, or the like, in the dynamic code which indicate a subscript. In some examples, a subscript object may be detected in the dynamic code. An object of the subscript object may be resolved to a sequence and a vlue of the sequence is resolved using the value transition graph.

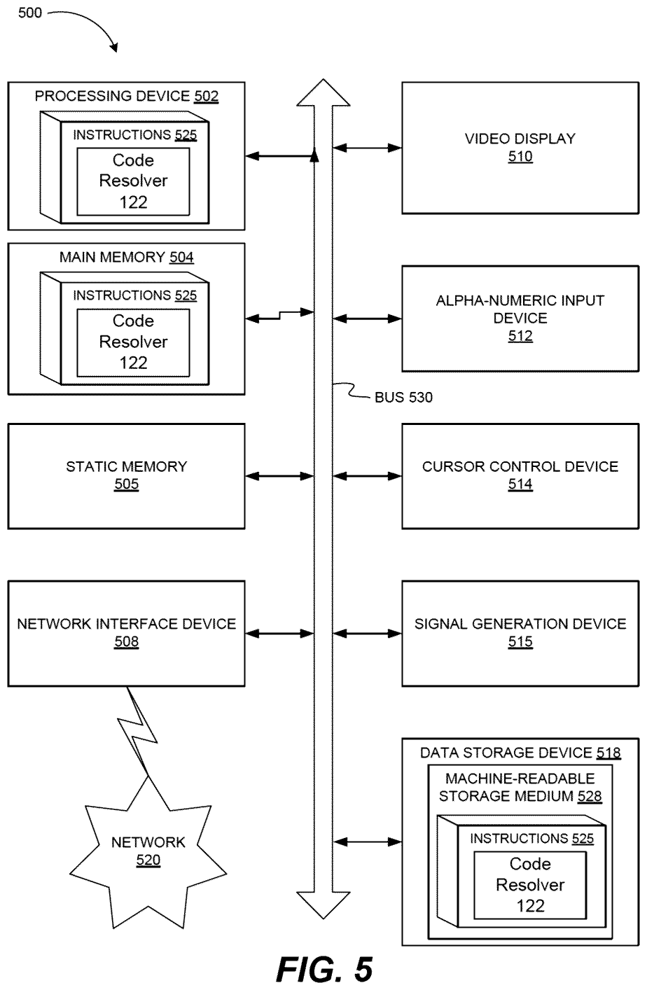

FIG. 5 illustrates a diagrammatic representation of a machine in the example form of a computer system 500 within which a set of instructions, for causing the machine to perform any one or more of the methodologies discussed herein.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, computer system 500 may be representative of a server.

The exemplary computer system 500 includes a processing device 502, a main memory 504 (e.g., read-only memory (ROM), flash memory, dynamic random access memory (DRAM), a static memory 506 (e.g., flash memory, static random access memory (SRAM), etc.), and a data storage device 518 which communicate with each other via a bus 530. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computer system 500 may further include a network interface device 508 which may communicate with a network 520. Computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse) and an acoustic signal generation device 516 (e.g., a speaker). In some embodiments, video display unit 510, alphanumeric input device 512, and cursor control device 514 may be combined into a single component or device (e.g., an LCD touch screen).

Processing device 502 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 is configured to execute instructions 525 for code resolver 122, for performing the operations and steps discussed herein.

The data storage device 518 may include a machine-readable storage medium 528, on which is stored one or more sets of instructions 525 (e.g., software) for code resolver 122 embodying any one or more of the methodologies of functions described herein. The instructions 525 for code resolver 122 may also reside, completely or at least partially, within the main memory 504 or within the processing device 502 during execution thereof by the computer system 500; the main memory 504 and the processing device 502 also constituting machine-readable storage media. The instructions 525 for code resolver 122 may further be transmitted or received over a network 520 via the network interface device 508.

The machine-readable storage medium 528 may also be used to store instructions to perform a method for intelligently scheduling containers, as described herein. While the machine-readable storage medium 528 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “replacing,” “providing,” “receiving,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112(f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method of resolving values of a dynamic language code object in static analysis, comprising:
accessing code of an application written in a dynamic programming language, wherein the application comprises a plurality of transition points;
detecting a plurality of values in the code of the application, wherein a first value of the plurality of values is associated with a first transition point of the plurality of transition points;
iteratively resolving the first transition point to the first value of the plurality of values or another transition point;
generating a value transition graph comprising a plurality of nodes and a plurality of edges connecting the plurality of nodes, wherein each node of the plurality of nodes represents a resolved transition point of the plurality of transition points; and
generating a node in the value transition graph for the first transition point in response to resolving the first transition point to the first value.

2. The method of claim 1, wherein resolving the first transition point of the plurality of transition points comprises:
determining whether the first transition point resolves to a predetermined data type; and
in response to determining that the first transition point does not resolve to a data type that is the predetermined data type, ceasing resolution of the first transition point.

3. The method of claim 1, wherein resolving the first transition point of the plurality of transition points comprises:
determining whether the first transition point resolves to a predefined transition type; and
in response to determining that the first transition point resolves to the predefined transition type, resolving the first transition point.

4. The method of claim 3, wherein the predefined transition type comprises at least one of a call, an attribute, a subscript, a collection access, an iteration, or a transition type that facilitates an inter-procedural flow of the application.

5. The method of claim 1, further comprising:
detecting a call from the first transition point to a second transition point;
resolving the second transition point to a predetermined data type; and
determining that the first transition point is fully resolved in response to determining that the second transition point is resolved.

6. The method of claim 1, further comprising:
generating a call graph based on the value transition graph;
identifying a function call in the code of the application;
resolving a second value of a function that is being called in the function call; and
generating a node in the call graph based on the function and the resolved second value of the function.

7. The method of claim 1, further comprising:
generating an attribute graph based on the value transition graph;
selecting, from the code of the application, an attribute store or an attribute load;
resolving a parent transition point of an attribute by detecting a parent of the attribute; and
resolving the parent transition point to a value in the attribute graph based on the value transition graph.

8. The method of claim 1, further comprising:
generating a subscript graph based on the value transition graph;
identifying, from the code of the application, a subscript operator;
resolving a key of the subscript operator to a sequence; and
resolving a value of the sequence utilizing the value transition graph.

9. The method of claim 1, further comprising:
storing, after a first iteration of resolving the first transition point, a first resolved transition point in a cache; and
resolving, during a second iteration of resolving the first transition point, a second transition point to the first resolved transition point in the cache.

10. A system comprising:
a processing device; and
a memory to store instructions that, when executed by the processing device cause the processing device to:
access code of an application written in a dynamic programming language, wherein the application comprises a plurality of transition points;
detect a plurality of values in the code of the application, wherein a first value of the plurality of values is associated with a first transition point of the plurality of transition points;
iteratively resolve the first transition point to the first value of the plurality of values or another transition point;
generate a value transition graph comprising a plurality of nodes and a plurality of edges connecting the plurality of nodes, wherein each node of the plurality of nodes represents a resolved transition point of the plurality of transition points; and
generate a node in the value transition graph for the first transition point in response to resolving the first transition point to the first value.

11. The system of claim 10, wherein to resolve the first transition point of the plurality of transition points, the processing device is to:
determine whether the first transition point resolves to a predetermined data type; and
in response to determining that the transition does not resolve to a data type that is the predetermined data type, cease resolution of the first transition point.

12. The system of claim 10, wherein to resolve the first transition point of the plurality of transition points, the processing device is to:
determine whether the first transition point resolves to a predefined transition type; and
in response to determining that the first transition point resolves to the predefined transition type, resolve the first transition point.

13. The system of claim 12, wherein the predefined transition type comprises at least one of a call, an attribute, a subscript, a collection access, an iteration, or a transition type that facilitates an inter-procedural flow of the application.

14. The system of claim 10, further comprising:
store, after a first iteration of resolving the first transition point, a first resolved transition point in a cache; and
resolve, during a second iteration of resolving the first transition point, a second transition point to the first resolved transition point in the cache.

15. The system of claim 10, further comprising:
generate at least one of a call graph, an attribute graph, or a subscript graph based on the value transition graph.

16. A non-transitory computer readable medium, having instructions stored thereon which, when executed by a processing device, cause the processing device to:
access code of an application written in a dynamic programming language, wherein the application comprises a plurality of transition points;
detect a plurality of values in the code of the application, wherein a first value of the plurality of values is associated with a first transition point of the plurality of transition points;
iteratively resolve the first transition point to the first value of the plurality of values or another transition point;
generate a value transition graph comprising a plurality of nodes and a plurality of edges connecting the plurality of nodes, wherein each node of the plurality of nodes represents a resolved transition point of the plurality of transition points; and
generate a node in the value transition graph for the first transition point in response to resolving the first transition point to the first value.

17. The non-transitory computer readable medium of claim 16, wherein to resolve the first transition point of the plurality of transition points, the processing device is to:
determine that the first transition point resolves to a predetermined data type; and
in response to determining that the first transition point does not resolve to a data type that is the predetermined data type, cease resolution of the first transition point.

18. The non-transitory computer readable medium of claim 16, wherein to resolve the first transition point of the plurality of transition points, the processing device is to:
determine whether the first transition point resolves to a predefined transition type; and
in response to determining that the first transition point resolves to the predefined transition type, resolve the first transition point.

19. The non-transitory computer readable medium of claim 18, wherein the predefined transition type comprises at least one of a call, an attribute, a subscript, a collection access, an iteration, or a transition type that facilitates an inter-procedural flow of the application.

20. The non-transitory computer readable medium of claim 16, further comprising:
store, after a first iteration of resolving transition points, a first resolved transition point in a cache; and
resolve, during a second iteration of resolving transition points, a second transition point to the first resolved transition point in the cache.
